(19) United States
(12) Patent Application Publication
(10) Pub. No.: US 2019/0012835 A1
(43) Pub. Date: Jan. 10, 2019

(54) Driving an Image Capture System to Serve Plural Image-Consuming Processes

(71) Applicant: Microsoft Technology Licensing, LLC, Redmond, WA (US)

(72) Inventors: Michael BLEYER, Seattle, WA (US); Raymond Kirk PRICE, Redmond, WA (US); Denis Claude Pierre DEMANDOLX, Bellevue, WA (US); Michael SAMPLES, Redmond, WA (US)

(21) Appl. No.: 15/643,494

(22) Filed: Jul. 7, 2017

(51) Int. Cl. G06T 19/00; G02B 27/01; G06F 3/01; G06T 19/20

(52) U.S. Cl. CPC G06T 19/006; G02B 27/0172; G06F 3/012; G02B 2027/0178; G06T 19/20; G02B 2027/014; G06F 3/013

(57) ABSTRACT

A technique is described herein that employs a resource-efficient image capture system. The image capture system includes an active illumination system for emitting electromagnetic radiation within a physical environment. The image capture system also includes a camera system that includes one or more cameras for detecting electromagnetic radiation received from the physical environment, to produce image information. In one implementation, the technique involves using the same image capture system to produce different kinds of image information for consumption by different respective image processing components. The technique can perform this task by allocating timeslots over a span of time for producing the different kinds of image information. In one case, the image processing components include: a pose tracking component; a controller tracking component; and a surface reconstruction component, etc., any subset of which may be active at any given time.

### BACKGROUND

Some head-mounted displays (HMDs) provide an augmented reality experience that combines virtual objects with a representation of real-world objects, to produce an augmented reality environment. Other HMDs provide a completely immersive virtual experience. In general, HMDs are technically complex devices that perform several image-processing functions directed to detecting the user's interaction with a physical environment. Due to this complexity, commercial HMDs are often offered at relatively high cost. The cost of HMDs may limit the marketability of these devices.

### SUMMARY

A resource-efficient technique is described herein for driving an image capture system to provide image information. The image capture system includes an active illumination system for emitting electromagnetic radiation within a physical environment. The image capture system also includes a camera system that includes one or more cameras for detecting electromagnetic radiation received from the physical environment, to produce image information. In one implementation, the technique involves using the same image capture system to produce different kinds of image information for consumption by different respective image processing components. The technique can perform this task by allocating timeslots over a span of time for producing the different kinds of image information.

In one case, the image processing components include: a pose tracking component; a controller tracking component; and a surface reconstruction component, etc., any subset of which may be active at any given time.

According to one benefit, the technique provides image information for consumption by plural image-consuming processes with a simplified image capture system, such as, in one example, an image capture system that includes only two visible light cameras. By virtue of this feature, the technique can reduce the cost and weight of a head-mounted display, while preserving the full range of its functionality. In other words, the technique solves the technical problem of how to simplify a complex device while preserving its core functionality.

The above technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview one manner of use of a head-mounted display in conjunction with at least one controller.

FIG. 2 shows an overview of a control framework provided by the head-mounted display of FIG. 1.

FIG. 3 shows a more detailed illustration of the head-mounted display of FIG. 1.

FIGS. 4 and 5 show one non-limiting implementation of a camera system associated with the head-mounted display of FIG. 3.

FIG. 6 shows an external appearance of one illustrative controller that can be used in conjunction with the head-mounted display of FIG. 3.

FIG. 7 shows components that may be included in the controller of FIG. 6.

FIGS. 8-10 show three respective ways of allocating timeslots for collecting component-targeted instances of image information, for consumption by different image processing components.

FIG. 11 shows one implementation of a mode control system, which is an element of the head-mounted display of FIG. 1.

FIG. 12 shows one implementation of a pose tracking component, which is one type of image processing component that can be used in the head-mounted display of FIG. 3.

FIG. 13 shows one implementation of a controller tracking component, which is another type of image processing component that can be used in the head-mounted display of FIG. 3.

FIG. 14 shows one implementation of a surface reconstruction component, which is another type of image processing component that can be used in the head-mounted display of FIG. 3.

FIG. 15 shows a process that describes an overview of one manner of operation of the head-mounted display of FIG. 3.

FIG. 16 shows a process that describes one manner of driving an image capture system of the head-mounted display of FIG. 3.

FIG. 17 shows an external appearance of the head-mounted display of FIG. 3, according to one non-limiting implementation.

FIG. 18 shows illustrative computing functionality that can be used to implement any processing-related aspect of the features shown in the foregoing drawings.

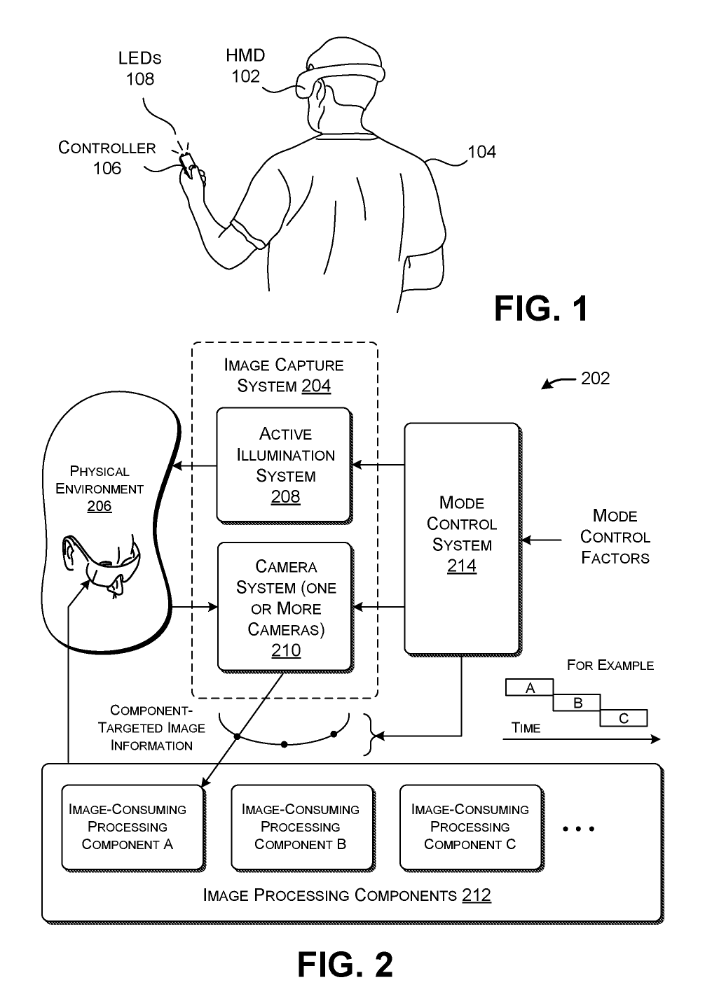

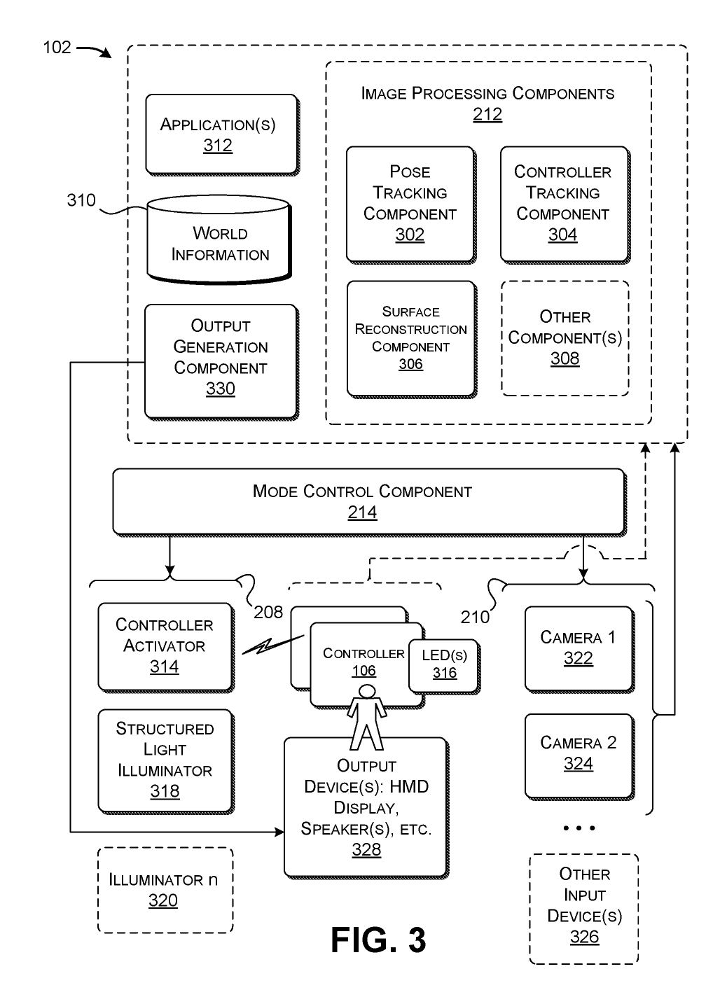

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes the operation of a resource-efficient computing device (such as a head-mounted display) for producing image information for consumption by different image-consuming processes. Section B describes the operation of the computing device of Section A in flowchart form. And Section C describes illustrative computing functionality that can be used to implement any processing-related aspect of the features described in the preceding sections.

As a preliminary matter, some of the figures describe concepts in the context of one or more structural components, also referred to as functionality, modules, features, elements, etc. In one implementation, the various processing-related components shown in the figures can be implemented by software running on computer equipment, or other logic hardware (e.g., FPGAs), etc., or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. Section C provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by software running on computer equipment, or other logic hardware (e.g., FPGAs), etc., or any combination thereof.

As to terminology, the phrase “configured to” encompasses various physical and tangible mechanisms for performing an identified processing-related operation. The mechanisms can be configured to perform an operation using, for instance, software running on computer equipment, or other logic hardware (e.g., FPGAs), etc., or any combination thereof.

The term “logic” encompasses various physical and tangible mechanisms for performing a task. For instance, each processing-related operation illustrated in the flowcharts corresponds to a logic component for performing that operation. A processing-relating operation can be performed using, for instance, software running on computer equipment, or other logic hardware (e.g., FPGAs), etc., or any combination thereof. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific terms “computer-readable storage medium” and “computer-readable storage medium device” expressly exclude propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative Computing Device

FIG. 1 shows one manner of use of a head-mounted display (HMD) 102 that includes a resource-efficient image capture system, described below. The HMD 102 corresponds to a headset worn by a user 104 that provides a modified-reality environment. In some implementations, the modified-reality environment combines representations of real-world objects in the physical environment with virtual objects. As such, the term “modified-reality” environment encompasses what is commonly referred to in the art as “augmented-reality” environments, “mixed-reality” environments, etc. In other cases, the modified-reality environment provides a completely immersive virtual world, e.g., without reference to real-world objects in the physical environment. To nevertheless facilitate explanation, the following explanation will assume that the modified-reality environment combines representations of real-world objects and virtual objects.

In one case, the HMD 102 can produce a modified-reality presentation by projecting virtual objects onto a partially-transparent display device. The user 104 views the physical environment through the partially-transparent display device, while the HMD 102 projects virtual objects onto the partially-transparent display device; through this process, the HMD 102 creates the illusion that the virtual objects are integrated with the physical environment. Alternatively, or in addition, the HMD 102 creates an electronic representation of real-world objects in the physical environment. The HMD 102 then integrates the virtual objects with the electronic version of the real-world objects, to produce the modified-reality presentation. The HMD 102 may project that modified-reality presentation on an opaque display device or a partially-transparent display device.

In yet other cases, some other type of computing device (besides a head-mounted display) can incorporate the resource-efficient image capture system. For instance, the computing device can correspond to a handheld computing device of any type, or some other type of wearable computing device (besides a head-mounted display). Or the computing device may correspond to the control system of a mobile robot of any type. For instance, the mobile robot can correspond to terrestrial robot, a drone, etc. To nevertheless facilitate explanation, the following explanation will assume that the computing device that implements the image capture system corresponds to a head-mounted display.

The user 104 also manipulates a controller 106. In the non-limiting example of FIG. 1, the controller 106 corresponds to a handheld device having one or more control mechanisms (e.g., buttons, control sticks, etc.). The user 104 may manipulate the control mechanisms to interact with the modified-reality world provided by the HMD 102. In other cases, the controller 106 can have any other form factor, such as a piece of apparel (e.g., a glove, shoe, etc.), a mock weapon, etc. Further note that FIG. 1 indicates that the user 104 manipulates a single controller 106. But, more generally, the user 104 may interact with any number of controllers. For instance, the user 104 may hold two controllers in his or her left and right hands, respectively. Alternatively, or in addition, the user 104 may affix one or more controllers to his or her legs, feet, etc., e.g., by fastening a controller to a shoe.

The controller 106 includes a light-emitting system that includes one or more light-emitting elements, such as one or more light-emitting diodes (LEDs) 108 (referred to in the plural below for brevity). As will be described in detail below, in some control modes, the HMD 102 instructs the controller 106 to pulse the LEDs 108. Simultaneously with each pulse, the HMD's image capture system collects image information that contains a representation of the illuminated LEDs 108. The HMD 102 leverages that image information to determine the location of the controller 106 within the modified-reality environment.

FIG. 2 shows an overview of a control framework 202 provided by the HMD 102 of FIG. 1. The control framework 202 corresponds to a subset of elements of the HMD 102. The control framework 202 specifically contains those elements of the HMD 102 which enables it to collect and process image information in a resource-efficient manner.

The control framework 202 includes an image capture system 204 that performs tasks associated with the collection of image information from a physical environment 206. The image capture system 204, in turn, includes an active illumination system 208 and a camera system 210. The active illumination system 208 includes one or more mechanisms for emitting electromagnetic radiation (e.g., visible light) within the physical environment, in such a manner that the electromagnetic radiation is detectable by the camera system 210. For instance, the active illumination system 208 can include a mechanism for instructing the controller(s) to activate their light-emitting system(s). In addition, the active illumination system 208 can include an illumination source for directing structured light onto surfaces in the physical environment.

The camera system 210 captures image information from the physical environment 206. In the example emphasized herein, the camera system 210 includes two visible light cameras, such as two grayscale video cameras, or two red-green-blue (RGB) video cameras. In other examples, the camera system 210 can include a single video camera of any type. In other examples, the camera system 210 can include more than two video cameras of any type(s), such as four grayscale video cameras.

A collection of image processing components 212 consume the image information provided by the camera system 210. FIG. 2 generically indicates that the image processing components include an image processing component A, an image processing component B, and an image processing component C. Generally stated, each image processing component requires a particular kind of image information to perform its particular task. In part, the “kind” of the image information may depend on: (a) whether the active illumination system 208 is emitting light into the physical environment 206 at the time that an instance of image information is captured; and, if so (b) whether the active illumination is produced by the LEDs of the controller(s) or a structured light illuminator, etc.

For example, the image processing component A may collect image information while all sub-components of the active illumination system 208 remain inactive. The image processing component B may collect image information while the light-emitting system(s) of the controller(s) are activated, but when no structured light is projected into the physical environment 206. The image processing component C may collect image information while structured light is projected into the physical environment 206, but when the light-emitting system(s) of the controller(s) are turned off, and so on. An instance of image information that is prepared for consumption by a particular kind of image processing component is referred to herein as component-targeted image information, that is, because the image information targets a particular image processing component.

Finally, a mode control system 214 identifies a control mode, and then governs the image capture system 204 in accordance with the control mode. A control mode generally refers to a subset of the image processing components 212 that are active at any given time. By extension, a control mode also refers to the kinds of image information that need to be supplied to the invoked image processing components. For instance, a first control mode indicates that only image processing component A is active, and, as a result, only component-targeted image information of type A is produced. A second control mode indicates that all three image processing components are active (A, B, and C), and, as result, component-targeted image information of types A, B, and C are produced.

The mode control system 214 determines the control mode based on one or more mode control factors. For instance, an application that is currently running may specify a mode control factor, which, in turn, identifies the image processing components that it requires to perform its tasks. For example, the application can indicate that it requires image processing component A, but not image processing component B or image processing component C.

Having selected a control mode, the mode control system 214 sends instruction to the active illumination system 208 and/or the camera system 210. Overall, the instructions synchronize the image capture system 204 such that it produces different kinds of image information in different respective time slots. More specifically, the mode control system 214 sends instructions to the active illumination system 208 (if applicable) and the camera system 210, causing these two systems (208, 210) to operate in synchronized coordination. For example, the mode control system 214 can control the image capture system 204 such that it produces a first kind of image information for consumption by the image processing component A during first instances of time (e.g., corresponds to first image frames). The mode control system 214 can also control the image capture system 204 such that it produces a second kind of image information for consumption by the image processing component B during second instances of time (e.g., correspond to second image frames), and so on. In this manner, the mode control system 214 can allocate the frames (or other identifiable image portions) within a stream of image information to different image-consuming processes.

In summary, note that the image capture system 204 can include a single camera system 210, e.g., which may include just two visible light cameras. But that single camera system 210 nevertheless generates image information for consumption by different image-consuming processes (e.g., depending on the kind(s) of illumination provided by the active illumination system 208). This characteristic of the HMD 102 reduces the cost and weight of HMD 102 by accommodating a simplified camera system, without sacrificing functionality.

For frame of reference, consider an alternative design that uses plural image capture systems. The plural image capture systems can include separate respective camera systems. These separate image capture systems can operate at the same time by detecting electromagnetic radiation having different respective wavelengths, e.g., by generating image information based on detected visible light for use by one or more image-consuming processes, and generating image information based on detected infrared radiation for use by one or more other image-consuming processes. This design is viable, but it drives up the cost and weight of a head-mounted display by including distinct capture systems. Moreover, this design might produce infrared cross-talk between the separate capture systems, e.g., in those cases in which the visible light camera(s) have at least some sensitivity in the infrared spectrum. The HMD 102 shown in FIG. 2 solves the technical problem of how to simplify a multi-system framework of a complex head-mounted display, while preserving the full range of its functionality. It does so by providing a single image capture system 204 that is multi-purposed to provide image information for consumption by plural image processing components 212.

FIG. 3 shows a more detailed illustration of the HMD 102 of FIG. 1. FIG. 3 also shows a high-level view of the controller 106 introduced in FIG. 1. The HMD 102 incorporates the elements of the control framework 202 described above, including an active illumination system 208, a camera system 210, a set of image processing components 212, and a mode control system 214. Again note that the control framework 202 is described in the illustrative context of a head-mounted display, but the control framework 202 can be used in other types of computing devices.

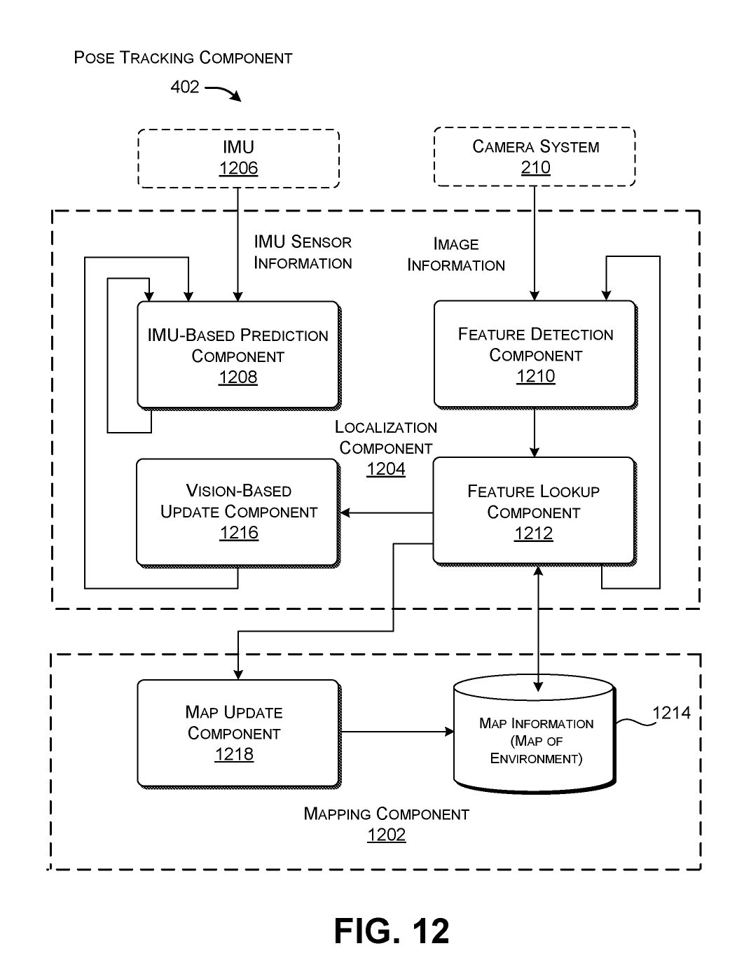

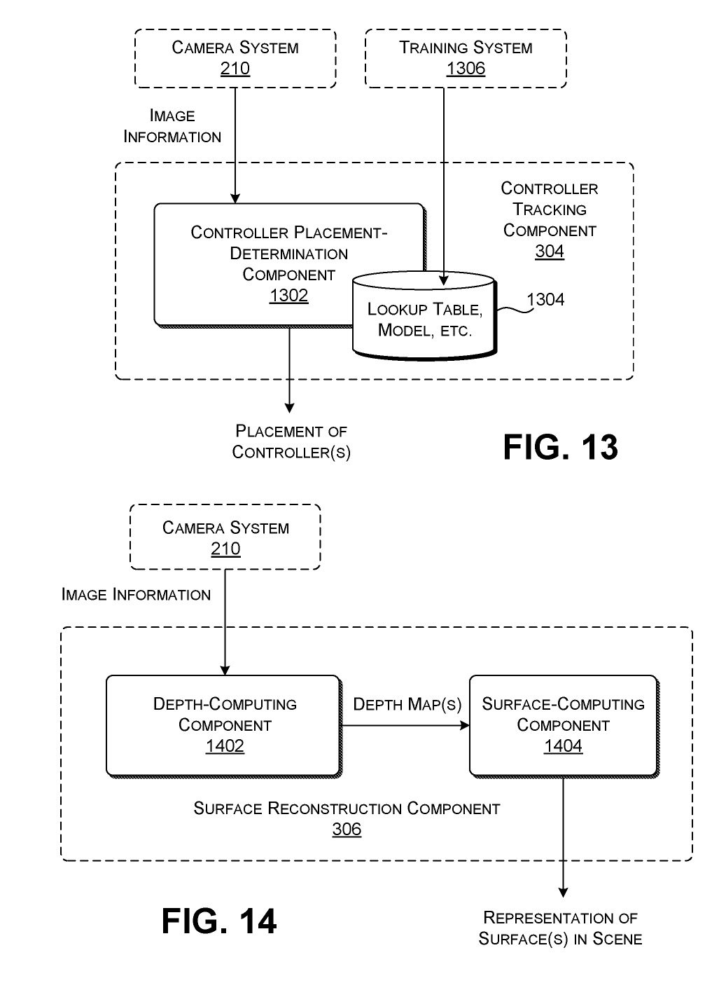

According to one illustrative and non-limiting implementation, the image processing components 212 include a pose tracking component 302, a controller tracking component 304, a surface reconstruction component 306, and/or one or more other image processing components 308. The pose tracking component 302 determines the position and orientation of the HMD 102 in a world coordinate system; by extension, the pose tracking component 302 also determines the position and orientation of the user's head, to which the HMD 102 is affixed. As will be described more fully in the context of FIG. 12, the pose tracking component 302 determines the pose of the HMD 102 using a simultaneous localization and mapping (SLAM) controller. A mapping component of the SLAM controller progressively builds a map of the physical environment based on stationary features that are detected within the physical environment. The mapping component stores the map in a data store 310. A localization component of the SLAM controller determines the position and orientation of the HMD 102 with reference to the map that has been built.

The pose tracking component 302 performs its task based on image information provided by the camera system 210, collected at those times when the active illumination system 208 is inactive. The pose tracking component 302 works best without active illumination within the physical environment because such illumination can potentially interfere with its calculations. More specifically, the pose tracking component 302 relies on the detection of stationary features within the physical environment. The pose tracking component 302 will therefore produce erroneous results by adding features to the map that correspond to the LEDs associated with the controller(s) or to the patterns (e.g., dots) of a structured light source, as these features move with the user and should not be categorized as being stationary.

The controller tracking component 304 determines the pose of each controller, such as the representative controller 106 that the user holds in his or her hand. By extension, the controller tracking component 304 determines the position and orientation of the user's hand(s) (or other body parts) which manipulate the controller(s), or to which the controller(s) are otherwise attached. As will be more fully described in the context of FIG. 13, in one implementation, the controller tracking component 304 determines the position and orientation of a controller by comparing captured image information that depicts the controller (and the controller's LEDs) with a set of instances of pre-stored image information. Each such instance depicts the controller at a respective position and orientation relative to the HMD 102. The controller tracking component 304 chooses the instance of pre-stored image information that most closely matches the captured image information. That instance of pre-stored image information is associated with pose information that identifies the position and orientation of the controller at the current point in time.

The controller tracking component 304 performs it task based on image information provided by the camera system 210, collected at those times when the active illumination system 208 activates the light-emitting system of each controller. Further, the camera system 210 collect the image information at those times that the active illumination system 208 is not directing structured light into the physical environment. The controller tracking component 304 works best without structured light within the physical environment because such illumination can potentially interfere with its calculations. For instance, the controller tracking component 304 can potentially mistake the structured light dots for the LEDs associated with the controller(s).

The surface reconstruction component 306 detects one or more surfaces within the physical environment, and provides a computer-generated representation of each such surface. As will be more fully described in the context of FIG. 14, in one implementation, the surface reconstruction component 306 generates a two-dimensional depth map for each instance of image information that it collects from the camera system 210. The surface reconstruction component 306 can then use one or more algorithms to identify meshes of scene points that correspond to surfaces within the physical environment. The surface reconstruction component 306 can also produce a representation of the surface(s) for output to the user.

The surface reconstruction component 306 performs it task based on image information provided by the camera system 210, collected at times when the active illumination system 208 is not simultaneously activating the LEDs of the controller(s). The surface reconstruction component 306 works best without illumination from the LEDs because such illumination can potentially interfere with its calculations. For instance, the surface reconstruction component 306 can potentially mistake the light from the LEDs with the structured light, especially when the structured light constitutes a speckle pattern composed of small dots that resemble LEDs.

The other image processing component(s) 308 generally denote any other image processing task(s) that are performed based on particular kind(s) of image information. For example, although not specifically enumerated in FIG. 3, the other image processing component(s) 308 can include an image segmentation component. The image segmentation component can distinguish principal objects within the physical environment, such as one or more principal foreground objects from a background portion of a captured scene.

The image segmentation component can perform its image-partitioning task based on image information collected by the camera system 210, produced when the active illumination system 208 floods the physical environment with a pulse of visible light. The intensity of this emitted light decreases as a function of the square of the distance from the illumination source. By virtue of this property, foreground objects will appear in the image information as predominately bright, and background objects will appear as predominately dark. The image segmentation component can leverage this property by labelling scene points with brightness values above a prescribed environment-specific intensity threshold value as pertaining to foreground objects, and labelling scene points having brightness values below a prescribed environment-specific intensity threshold value as corresponding to background objects.

Different applications 312 can use different subsets of the image processing components 212 in different ways. For example, a game application may involve interaction between the user and one or more virtual game characters. That kind of application may use the services of the pose tracking component 302, the controller tracking component 304, and the surface reconstruction component 306. The controller tracking component 304 is particularly useful in detecting the movement of the user's hands or other body parts, e.g., when the user moves a simulated weapon in the course of fighting a virtual character. Another type of application may provide information to the user as the user navigates within the modified-reality environment, but does not otherwise detect gestures performed by the user within the environment. That kind of application may rely on just the pose tracking component 302.

As previously described, the mode control system 214 determines a control mode to be invoked based on one or more mode control factors. The mode control factors can include information that describes the requirements of the applications 312 that are currently running. The mode control system 214 then sends control instructions to the image capture system 204. The control instructions operate to synchronize the image capture system 204 such that the appropriate kinds of image information are collected at the appropriate times.

Now referring to the image capture system 204 itself, as described above, it includes an active illumination system 208 and a camera system 210. The active illumination system 208 includes a controller activator 314 for interacting with one or more controllers, such as the representative controller 106. The representative controller 106, in turn, includes a light-emitting system, such as one or more LEDs 316. The controller activator 314 interacts with the controller(s) by sending instructions to the controller(s). The instructions command the controller(s) to activate their LEDs. More specifically, in one case, the instructions direct each controller to pulse its LEDs at a prescribed timing, synchronized with the image capture system 210. The controller activator 314 can send the instructions to each controller through any communication conduit, such as via wireless communication (e.g., BLUETOOTH), or by a physical communication cable.

A structured light illuminator 318 directs structured light into the physical environment. In one case, the structured light illuminator 318 corresponds to a collimated laser that directs light through a diffraction grating. The structured light can correspond to a speckle pattern, a stripe pattern, and/or any other pattern. In one case, a speckle pattern corresponds to a random set of dots which illuminate surfaces in the physical environment. The structured light illuminator 318 produces the structured light patterns in a pulsed manner. The camera system 210 captures an image of the illuminated scene in synchronization with each illumination pulse. The surface reconstruction component 306 consumes the resultant image information produced by the structured light illuminator 318 and the camera system 210 in this coordinated manner.

The active illumination system 208 can also include one or more other environment-specific illumination sources, such as the generically-labeled illuminator n 320. For instance, the illuminator n 320 can correspond to an illumination source (e.g., a laser, light-emitting diode, etc.) that projects a pulse of visible light into the physical environment. An image segmentation processor can rely on the image information collected by the camera system 210 during the illumination produced by the illuminator n 320.

The camera system 210 can include any number of cameras. In the examples emphasized herein, the camera system 210 includes two visible light cameras (322, 324), such as two grayscale cameras, each having, without limitation, a resolution of 640×480 pixels. At each instance of image collection, the two cameras (322, 324) provide image information that represents a stereoscopic representation of the physical environment. One or more of the image processing components 212 can determine the depth of scene points based on the stereoscopic nature of that image information.

The HMD 102 also includes one or more other inputs devices 326. The input devices 326 can include, but are not limited to: an optional gaze-tracking system, an inertial measurement unit (IMU), one or more microphones, etc.

In one implementation, the IMU can determine the movement of the HMD 102 in six degrees of freedom. The IMU can include one or more accelerometers, one or more gyroscopes, and/or one or more magnetometers, etc. In addition, the input devices 326 can incorporate other position-determining mechanisms for determining the position of the HMD 102, such as a global positioning system (GPS) system, a beacon-sensing system, a wireless triangulation system, a dead-reckoning system, a near-field-communication (NFC) system, etc., or any combination thereof.

The optional gaze-tracking system can determine the position of the user's eyes, e.g., by projecting light onto the user's eyes, and measuring the resultant glints that are reflected from the user's eyes. Illustrative information regarding the general topic of eye-tracking can be found, for instance, in U.S. Patent Application No. 20140375789 to Lou, et al., published on Dec. 25, 2014, entitled “Eye-Tracking System for Head-Mounted Display.” In other implementations, to reduce the cost and weight of the HMD 102, the HMD 102 may omit the gaze-tracking system.

One or more output devices 328 provide a representation of the modified-reality environment. The output devices 328 can include any combination of display devices, including a liquid crystal display panel, an organic light-emitting diode panel (OLED), a digital light projector, etc. In one implementation, the output devices 328 can include a semi-transparent display mechanism. That mechanism provides a display surface on which virtual objects may be presented, while simultaneously allowing the user to view the physical environment “behind” the display device. The user perceives the virtual objects as being overlaid on the physical environment and integrated with the physical environment. In other examples, the output devices 328 can include an opaque (non-see-through) display mechanism.

The output devices 328 may also include one or more speakers. The speakers can provide known techniques (e.g., using a head-related transfer function (HRTF)) to provide directional sound information, which the user perceives as originating from a particular location within the physical environment.

An output generation component 330 provides output information to the output devices 328. For instance, the output generation component 330 can use known graphics pipeline technology to produce a three-dimensional (or two-dimensional) representation of the modified-reality environment. The graphics pipeline technology can include vertex processing, texture processing, object clipping processing, lighting processing, rasterization, etc. Overall, the graphics pipeline technology can represent surfaces in a scene using meshes of connected triangles or other geometric primitives. Background information regarding the general topic of graphics processing is described, for instance, in Hughes, et al., Computer Graphics: Principles and Practices, Third Edition, Adison-Wesley publishers, 2014. The output generation component 330 can also produce images for presentation to the left and rights eyes of the user, to produce the illusion of depth based on the principle of stereopsis.

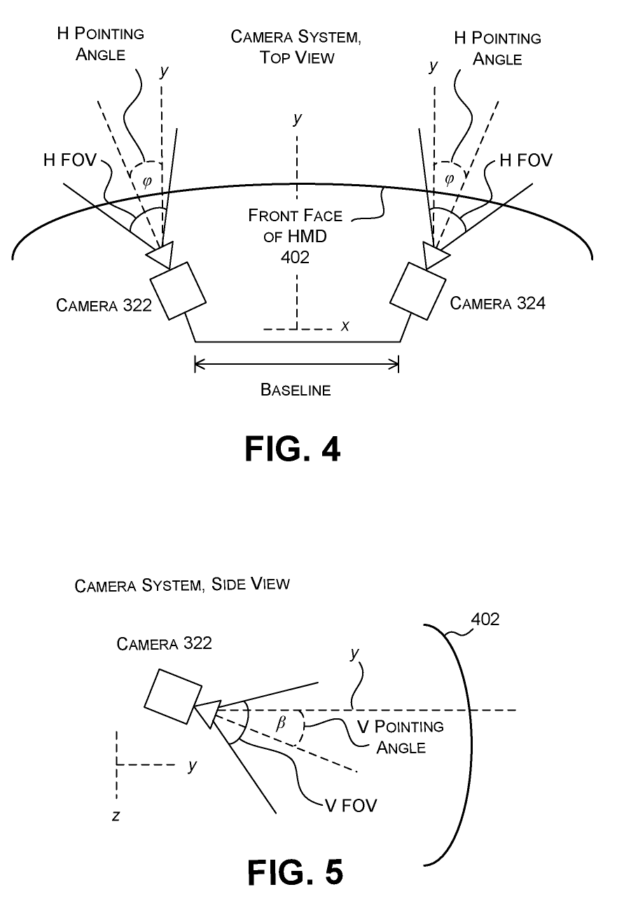

FIG. 4 shows one illustrative and non-limiting configuration of the camera system 210 of FIGS. 1 and 3, including the camera 322 and the camera 324. In particular, FIG. 4 shows a top-down view of the camera system 210 as if looking down on the camera system 210 from above the user who is wearing the HMD 102. Assume that a line connecting the two cameras (322, 324) defines a first device axis, and a line that extends normal to a front face 402 of the HMD 102 defines a second device axis. In one non-limiting case, the two cameras (322, 324) are separated by a distance of approximately 10 cm. Each camera (322, 324) is tilted with respect to the second axis by approximately 25 degrees. Each camera (322, 324) has a horizontal field-of-view (FOV) of approximately 120 degrees.

FIG. 5 shows a side view of one of the cameras, such as camera 322. The camera 324 is tilted below a plane (defined by the first and second device axes) by approximately 21 degrees. The camera 322 has a vertical FOV of approximately 94 degrees. The same specifications apply to the other camera 324.

The above-described parameters values are illustrative of one implementation among many, and can be varied based on the applications to which the HMD 102 is applied, and/or based on any other environment-specific factors. For example, a particular application may entail work performed within a narrow zone in front of the user. A head-mounted display that is specifically designed for that application can use a narrower field-of-view compared to that specified above, and/or can provide pointing angles that aim the cameras (322, 324) more directly at the work zone.

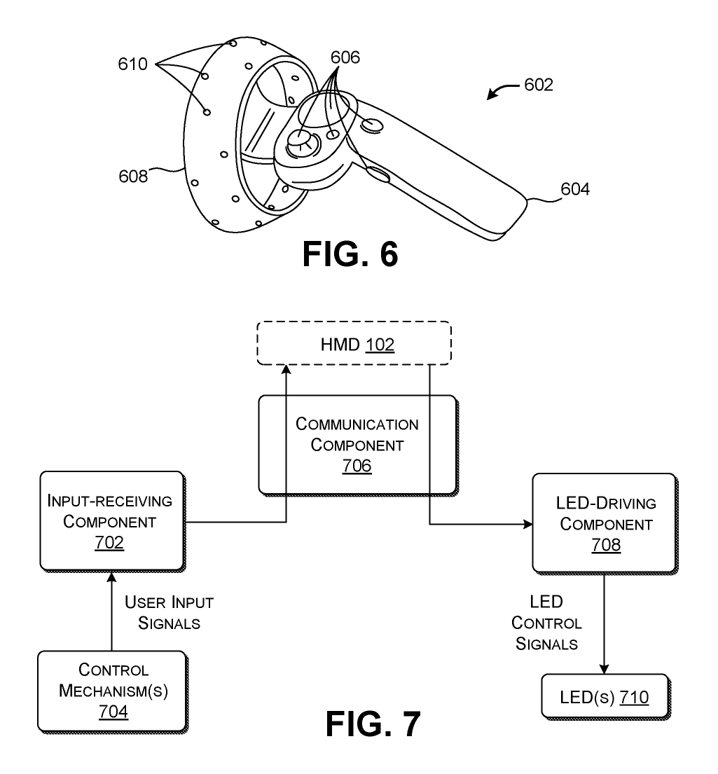

FIG. 6 shows an external appearance of one illustrative controller 602 that can be used in conjunction with the HMD 102 of FIGS. 1 and 3. The controller 602 includes an elongate shaft 604 that the user grips in his or her hand during use. The controller 602 further includes a set of input mechanisms 606 that the user actuates while interacting with a modified-reality environment. The controller 602 also includes a ring 608 having an array of LEDs (e.g., LEDs 610) dispersed over its surface. The camera system 210 captures a representation of the array of LEDs at a particular instance of time. The controller tracking component 304 (of FIG. 3) determines the position and orientation of the controller 602 based on the position and orientation of the array of LEDs, as that array appears in the captured image information. Other controllers can have any other shape compared to that described above and/or can include any other arrangement of LEDs (and/or other light-emitting elements) compared to that described above (such as a rectangular array of LEDs, etc.).

FIG. 7 shows components that may be included in the controller 602 of FIG. 6. An input-receiving component 702 receives input signals from one or more control mechanisms 704 provided by the controller 602. A communication component 706 passes the input signals to the HMD 102, e.g., via a wireless communication channel, a hardwired communication cable, etc. Further, an LED-driving component 708 receives control instructions from the HMD 102 via the communication component 706. The LED-driving component 708 pulses an array of LEDs 710 in accordance with the control instructions.

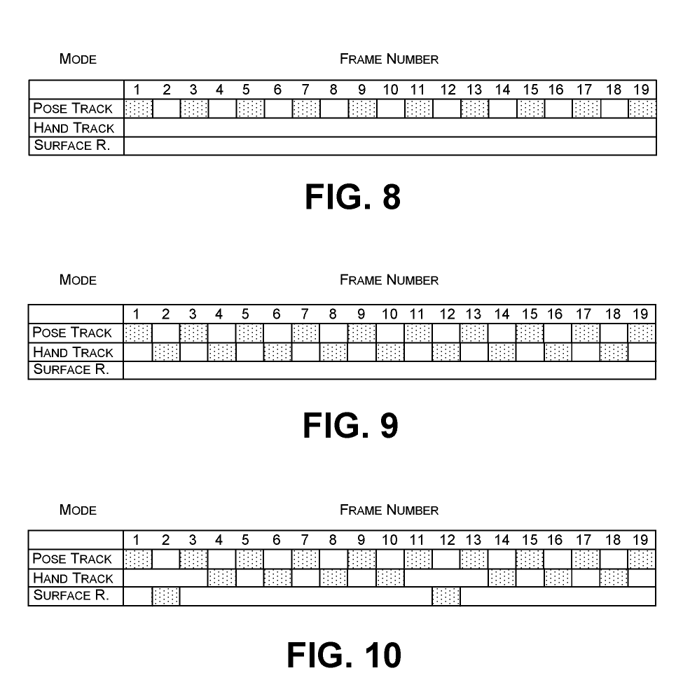

FIGS. 8-10 show three respective ways of allocating timeslots to collect component-targeted instances of image information, for consumption by different image processing components. In one non-limiting case, the camera system 210 captures frames at a given rate, such as, without limitation, 60 frames per second, etc.

Beginning with FIG. 8, in this case, the image capture system 204 only provides instances of image information for consumption by the pose tracking component 302, e.g., in odd (or even) image frames. During these instances, the active illumination system 208 remains inactive, meaning that no active illumination is emitted into the physical environment. In this example, the image capture system 204 does not capture image information in the even image frames. But in another implementation, the image capture system 204 can collect instances of image information for consumption by the pose tracking component 302 in every image frame, instead of just the odd (or even) image frames. In another implementation, the image capture system 204 can collect instances of image information for use by the pose tracking component 302 at a lower rate compared to that shown in FIG. 8, e.g., by collecting instances of image information every third image frame.

In FIG. 9, the image capture system 204 collects first instances of image information for consumption by the pose tracking component 302, e.g., in the odd image frames. Further, the image capture system 204 collects second instances of image information for consumption by the controller (e.g., hand) tracking component 304, e.g., in the even image frames. During collection of the first instances of image information, the active illumination system 208 remains inactive as a whole. During collection of the second instances of image information, the controller activator 314 sends control instructions to the controller(s), which, when carried out, have the effect of the pulsing the LED(s) of the controller(s). That is, during each second instance, the controller activator 316 instructs each controller to generate a pulse of light using its light-emitting system; simultaneously therewith, the camera system 210 collects image information for consumption by the controller tracking component 304. But during the second instances, the structured light illuminator 318 remains inactive.

In FIG. 10, the image capture system 204 collects first instances of image information for consumption by the pose tracking component 302, e.g., in the odd image frames. Further, the image capture system 204 collects second instances of image information for consumption by the controller tracking component 304, e.g., in a subset of the even image frames. Further still, the image capture system 204 collects third instances of image information for consumption by the surface reconstruction component 306, e.g., in another subset of the even image frames. During collection of the first instances of image information, the active illumination system 208 as a whole remains inactive. During collection of the second instances of image information, the controller activator 314 sends control instructions to the controller(s), but, at these times, the structured light illuminator 318 remain inactive. That is, during each second instance, the controller activator 316 instructs each controller to generate a pulse of light using its light-emitting system; simultaneously therewith, the camera system 210 collects image information for consumption by the controller tracking component 304. During collection of the third instances of image information, the structured light illuminator 318 projects structured light into the physical environment, but, at these times, the controller activator 314 remains inactive. That is, during each third instance, the structured light emitter 318 generates a pulse of structured light; simultaneously therewith, the camera system 210 collects image information for consumption by the surface reconstruction component 306.

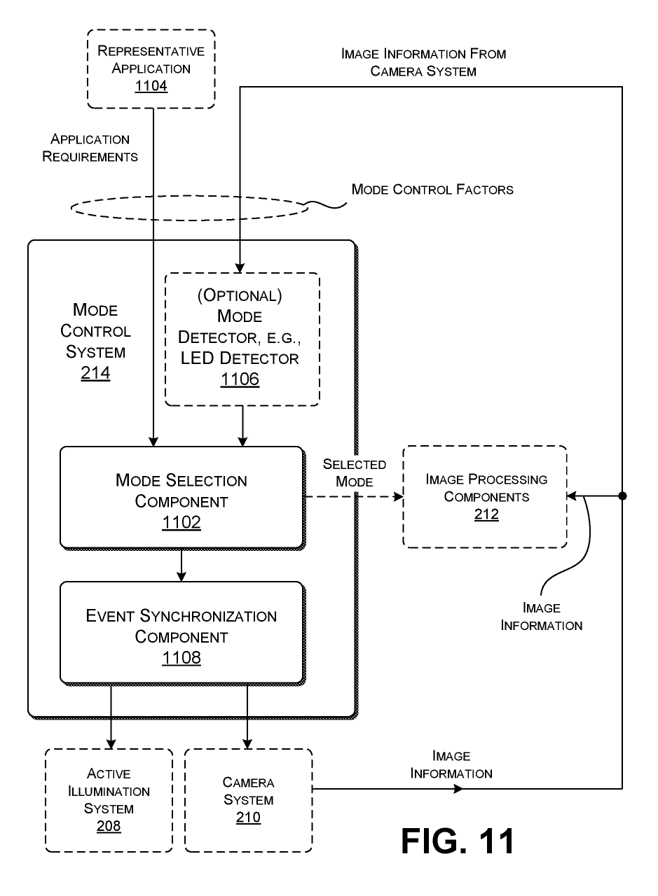

FIG. 11 shows one implementation of the mode control system 214. The mode control system 214 includes a mode selection component 1102 that determines a control mode to be activated based on one or more mode control factors. In one implementation, each application 1104 that is running specifies a mode control factor. That mode control factor, in turn, identifies the image processing components that are required by the application 1104. For example, one kind of game application can specify that it requires the pose tracking component 302 and the controller tracking component 304, but not the surface reconstruction component 306.

More specifically, in some cases, the application 1104 relies on one or more image processing components throughout its operation, and does not rely on other image processing components. In other cases, the application 1104 relies on one or more image processing components in certain stages or aspects of its operation, but not in other stages or aspects of its operation. In the latter case, the application can provide an updated mode control factor whenever its needs change with respect to its use of image processing components. For example, an application may use the surface reconstruction component 306 in an initial period when it is first invoked. The surface reconstruction component 306 will generate computer-generated surfaces that describe the physical surfaces in the room or other locale in which the user is currently using the application. When all of the surfaces have been inventoried, the application will thereafter discontinue use of the surface reconstruction component 306, so long as the user remains within the same room or locale.

An optional mode detector 1106 can also play a part in the selection of a control mode. The mode detector 1106 receives an instance of image information captured by the camera system 210. The mode detector 1106 determines whether the image information contains evidence that indicates that a particular mode should be invoked. In view thereof, the image information that has been fed to the mode detector 1106 can be considered as another mode control factor.

Consider the following scenario to illustrate the role of the mode detector 1106. Assume that the application 1104 can be used with or without controllers. That is, the application 1104 can rely on the controller tracking component 304 in some use cases, but not in other use cases. In an initial state, the application 1104 specifies a mode control factor that identifies a default control mode. The default control mode makes the default assumption that the user is not using a controller. In accordance with that default control mode, the image capture system 204 is instructed to capture an instance of image information for processing by the mode detector 1106 every k frames, such as, without limitation, every 60 frames (e.g., once per second). The mode detector 1106 analyzes each k^{th} image frame to determine whether it reveals the presence of LEDs associated with a controller.

Assume that the mode detector 1106 detects LEDs in the captured image information, indicating the user has started to use a controller. If so, the mode detector 1106 sends updated information to the mode selection component 1102. The mode selection component 1102 responds by changing the control mode of the HID 102. For instance, the mode selection component 1102 can instruct the image capture system 204 to capture image information for use by the controller tracking component 304 every other frame, as in the example shown in FIG. 9. The mode detector 1106 can continue to monitor the image information collected every k^{th} frame. If it concludes that the user is no longer using the controller, it can revert to the first-mentioned control mode.

In one implementation, the mode selection component 1102 performs it task using a lookup table. The lookup table maps a particular combination of mode control factors to an indication of a control mode to be invoked. As previously described, a control mode generally identifies the subset of image processing components 212 that are needed at any particular time by the application(s) that are currently running. By extension, a control mode also identifies the kinds of image information that need to be collected to serve the image processing components 212.

An event synchronization component 1108 maps a selected control mode into the specific control instructions to be sent to the active illumination system 208 and the camera system 210. The control instructions sent to the active illumination system 208 specify the timing at which the controller activator 314 pulses the LEDs of the controller(s) and/or the timing at which the structure light illuminator 318 projects structured light into the physical environment. The control instructions sent to the camera system 210 specify that timing at which its camera(s) (322, 324) collect instances of image information. In those cases in which active illumination is used, the camera(s) (322, 324) capture each instance of image information in a relatively short exposure time, timed to coincide with the emission of active illumination into the physical environment. The short exposure time helps to reduce the ambient light captured from the environment, meaning any light that is not attributable to an active illumination source. The short exposure time also reduces consumption of power by the HMD 102.

The remaining portion of Section A describes the illustrative operation of the pose tracking component 302, the controller tracking component 304, and the surface reconstruction component 306. However, other implementations of the principles described herein can use a different subset of image processing components.

Pose Tracking

FIG. 12 shows one implementation of the pose tracking component 302. In some cases, the pose tracking component 302 includes a map-building component 1202 and a localization component 1204. The map-building component 1202 builds map information that represents the physical environment, while the localization component 1204 tracks the pose of the HMD 102 with respect to the map information. The map-building component 1202 operates on the basis of image information provided by the camera system 210. Assume that the camera system 210 provides two monochrome cameras (322, 324) (as shown in FIG. 3). The localization component 1204 operates on the basis of the image information provided by the cameras (322, 324) and movement information provided by at least one inertial measurement unit (IMU) 1206. As described above, the IMU 1206 can include one or more accelerometers, one or more gyroscopes, and/or one or more magnetometers, and so on.

More specifically, beginning with the localization component 1204, an IMU-based prediction component 1208 predicts the pose of the HMD 102 based on a last estimate of the pose in conjunction with the movement information provided by the IMU 1206. For instance, the IMU-based prediction component 1208 can integrate the movement information provided by the IMU 1206 since the pose was last computed, to provide a movement delta value. The movement delta value reflects a change in the pose of the computing device since the pose was last computed. The IMU-based prediction component 1208 can add this movement delta value to the last estimate of the pose, to thereby update the pose.

A feature detection component 1210 determines features in the image information provided by the camera system 210. For example, the feature detection component 1210 can use any kind of image operation to perform this task. For instance, the feature detection component 1210 can use a Scale-Invariant Feature Transform (or SIFT) operator.

A feature lookup component 1212 determines whether the features identified by the feature detection component 1210 match any previously stored features in the current map information (as provided in a data store 1214). The feature lookup component 1212 can perform the above-described operation in different ways. Consider the case of a single discovered feature that is identified in the input image information. In one approach, the feature lookup component 1212 can exhaustively examine the map information to determine whether it contains any previously-encountered feature that is sufficiently similar to the discovered feature, with respect to any metric of feature similarity. In another approach, the feature lookup component 1212 can identify a search region within the map information, defining the portion of the environment that should be visible to the HMD 102, based on a current estimate of the pose of the HMD 102. The feature lookup component 1212 can then search that region within the map information to determine whether it contains a previously-encountered feature that matches the discovered feature.

A vision-based update component 1216 updates the pose of the HMD 102 on the basis of any features discovered by the feature lookup component 1212. In one approach, the vision-based update component 1216 can determine the presumed position and orientation of the HMD 102 through triangulation or a like position-determining technique. The vision-based update component 1216 performs this operation based on the known positions of two or more detected features in the image information. A position of a detected feature is known when that feature has been detected on a prior occasion, and the estimated location of that feature has been stored in the data store 1214.

In one mode of operation, the IMU-based prediction component 1208 operates at a first rate, while the vision-based update component 1216 operates at a second rate, where the first rate is greater than the second rate. The localization component 1204 can opt to operate in this mode because the computations performed by the IMU-based prediction component 1208 are significantly less complex than the operations performed by the vision-based update component 1216 (and the associated feature detection component 1210 and feature lookup component 1212). But the predictions generated by the IMU-based prediction component 1208 are more subject to error and drift compared to the estimates of the vision-based update component 1216. Hence, the processing performed by the vision-based update component 1216 serves as a correction to the less complex computations performed by the IMU-based prediction component 1208.

Now referring to the map-building component 1202, a map update component 1218 adds a new feature to the map information (in the data store 1214) when the feature lookup component 1212 determines that a feature has been detected that has no matching counterpart in the map information. In one non-limiting implementation, the map update component 1218 can store each feature as an image patch, e.g., corresponding to that portion of an input image that contains the feature. The map update component 1218 can also store the position of the feature, with respect to the world coordinate system.

In one non-limiting implementation, the localization component 1204 and the map-building component 1202 can be implemented as any kind of SLAM-related technology. In one implementation, the localization component 1204 and the map-building component 1202 can use an Extended Kalman Filter (EFK) to perform the SLAM operations. An EFK maintains map information in the form of a state vector and a correlation matrix. In another implementation, the localization component 1204 and the map-building component 1202 can use a Rao-Blackwellised filter to perform the SLAM operations.

Background information regarding the general topic of SLAM can be found in various sources, such as Durrant-Whyte, et al., “Simultaneous Localisation and Mapping (SLAM): Part I The Essential Algorithms,” in IEEE Robotics & Automation Magazine, Vol. 13, No. 2, July 2006, pp. 99-110, and Bailey, et al., “Simultaneous Localization and Mapping (SLAM): Part II,” in IEEE Robotics & Automation Magazine, Vol. 13, No. 3, September 2006, pp. 108-117.

In some cases, the localization component 1204 and the map-building component 1202 can perform their SLAM-related functions with respect to image information produced by a single camera, rather than, for instance, two or more cameras. The localization component 1204 and the map-building component 1202 can perform mapping and localization in this situation using a MonoSLAM technique. A MonoSLAM technique estimates the depth of feature points based on image information captured in a series of frames, e.g., by relying on the temporal dimension to identify depth. Background information regarding one version of the MonoSLAM technique can be found in Davidson, et al., “MonoSLAM: Real-Time Single Camera SLAM,” in IEEE Transactions on Pattern Analysis and Machine Intelligence, Vol. 29, No. 6, June 2007, pp. 1052-1067.

Controller Tracking

FIG. 13 shows one implementation of the controller tracking component 304. The controller tracking component 304 receives image information during an instance of time at which the LEDs of at least one controller are illuminated. That image information provides a representation of the controller at a particular position and orientation with respect to the HMD 102. A controller placement-determination component 1302 maps the image information into a determination of the current position and orientation of the controller relative to the HMD 102.

In one approach, the controller placement-determination component 1302 relies on a lookup table 1304 to perform the above mapping. The lookup table 1304 contains a set of images that correspond to the different positions and orientations of the controller relative to the HMD 102. The lookup table 1304 also stores the position and orientation that is associated with each such image. A training system 1306 populates the lookup table 1304 with this image information in an offline process, which may be performed at the manufacturing site. In the real-time phase of operation, the controller placement-determination component 1302 performs an image-matching operation to determine the stored instance of image information (in the lookup table 1304) that most closely resembles the current instance of image information (captured by the camera system 210). The controller-placement determination component 1302 outputs the position and orientation associated with the closest-matching instance of image information; that position and orientation defines the current placement of the controller.

In another approach, the controller placement-determination component 1302 relies on a machine-learned model, such as, without limitation, a deep neural network model. The training system 1306 generates the model in an offline training process based on a corpus of images, where those images have been tagged with position and orientation information. In the real-time phase of operation, the controller placement-determination component 1302 feeds the current instance of captured image information as input into the machine-learned model. The machine-learned model outputs an estimate of the position and orientation of the controller at the current point time.

Note that a camera system 210 that uses two cameras (322, 324) produces two instances of image information at each sampling time. In one scenario, only one instance of image information (originating from one camera) captures a representation of a controller. If so, the controller placement-determination component 1302 performs it analysis based on that single instance of image information. In another scenario, both instances of image information contain representations of the controller. In that case, the controller placement-determination component 1302 can separately perform the above-described analysis for each instance of image information, and then average the results of its separate analyses. Or the controller placement-determination component 1302 can simultaneously analyze both instance of image information, such as by feeding both instances of image information as input into a machine-learned model.

The controller tracking component 304 can use yet other approaches. For example, presuming that a controller is visible in two instances of image information, the controller placement-determination component 1302 can use a stereoscopic calculation to determine the position and orientation of the controller, e.g., by dispensing with the above-described use of the lookup table 1304 or machine-trained model. For those cases in which the controller is visible in only one instance of image information, the controller placement-determination component 1302 can use the lookup table 1304 or machine-learned model.

Finally, the above description was predicted on the simplified case in which an instance of image information reveals the presence of a single controller, such as the single controller 106 shown in FIG. 1. If an instance of captured image information reveals the presence of two or more controllers (e.g., as manipulated by the left and right hands of the user), then the controller placement-determination component 1302 can perform the above-described image-matching operation for each portion of the captured image information that shows a controller (and its associated LEDs).

Surface Reconstruction

FIG. 14 shows one implementation of the surface reconstruction component 306. The surface reconstruction component 306 identifies surfaces in the physical environment based on image information provided by the camera system 210. The surface reconstruction component 306 can also generate computer-generated representations of the surfaces for display by the HMD's display device. The surface reconstruction component 306 operates based on image information captured by the camera system 210 when the structured light illuminator 318 illuminates the physical environment.

The surface reconstruction component 306 includes a depth-computing component 1402 for generating a depth map based on each instance of image information. The depth-computing component 1402 can perform this task by using stereoscopic calculations to determine the position of dots (or other shapes) projected onto surfaces in the physical environment by the structured light illuminator 318. This manner of operation assumes that the camera system 210 uses at least two cameras (e.g., cameras 322, 324). In other cases, the depth-computing component 1402 can perform this task by processing image information generated by a single camera. Here, the depth-computing component 1402 determines the depth of scene points in the environment by comparing the original structured light pattern emitted by the structured light illuminator 318 with the detected structured light pattern. Background information regarding one illustrative technique for inferring depth using structured light is described in U.S. Pat. No. 8,050,461 to Shpunt, et al., entitled “Depth-Varying Light Fields for Three Dimensional Sensing,” which issued on Nov. 1, 2011.

A surface-computing component 1404 next identifies surfaces in the image information based on the depth map(s) computed by the depth-computing component 1402. In one approach, the surface-computing component 1404 can identify principal surfaces in a scene by analyzing a 2D depth map. For instance, the surface-computing component 1404 can determine that a given depth value is connected to a neighboring depth value (and therefore likely part of a same surface) when the given depth value is no more than a prescribed distance from the neighboring depth value. In performing this task, the surface-computing component 1404 can also use any least-squares-fitting techniques, polynomial-fitting techniques, patch-assembling techniques, etc.

Alternatively, or in addition, the surface-computing component 1404 can use known fusion techniques to reconstruct the three-dimensional shapes of objects in a scene by fusing together knowledge provided by plural depth maps. Illustrative background information regarding the general topic of fusion-based surface reconstruction can be found, for instance, in: Keller, et al., “Real-time 3D Reconstruction in Dynamic Scenes using Point-based Fusion,” in Proceedings of the 2013 International Conference on 3D Vision, 2013, pp. 1-8; Izadi, et al., “KinectFusion: Real-time 3D Reconstruction and Interaction Using a Moving Depth Camera,” in Proceedings of the 24th Annual ACM Symposium on User Interface Software and Technology, October 2011, pp. 559-568; and Chen, et al., “Scalable Real-time Volumetric Surface Reconstruction,” in ACM Transactions on Graphics (TOG), Vol. 32, Issue 4, July 2013, pp. 113-1 to 113-10.

Additional information regarding the general topic of surface reconstruction can be found in: U.S. Patent Application No. 20110109617 to Snook, et al., published on May 12, 2011, entitled “Visualizing Depth”; U.S. Patent Application No. 20150145985 to Gourlay, et al., published on May 28, 2015, entitled “Large-Scale Surface Reconstruction that is Robust Against Tracking and Mapping Errors”; U.S. Patent Application No. 20130106852 to Woodhouse, et al., published on May 2, 2013, entitled “Mesh Generation from Depth Images”; U.S. Patent Application No. 20150228114 to Shapira, et al., published on Aug. 13, 2015, entitled “Contour Completion for Augmenting Surface Reconstructions”; U.S. Patent Application No. 20160027217 to da Veiga, et al., published on Jan. 28, 2016, entitled “Use of Surface Reconstruction Data to Identity Real World Floor”; U.S. Patent Application No. 20160110917 to Iverson, et al., published on Apr. 21, 2016, entitled “Scanning and Processing Objects into Tree-Dimensional Mesh Models”; U.S. Patent Application No. 20160307367 to Chuang, et al., published on Oct. 20, 2016, entitled “Raster-Based mesh Decimation”; U.S. Patent Application No. 20160364907 to Schoenberg, published on Dec. 15, 2016, entitled “Selective Surface Mesh Regeneration for 3-Dimensional Renderings”; and U.S. Patent Application No. 20170004649 to Collet Romea, et al., published on Jan. 5, 2017, entitled “Mixed Three Dimensional Scene Reconstruction from Plural Surface Models.”

B. Illustrative Processes

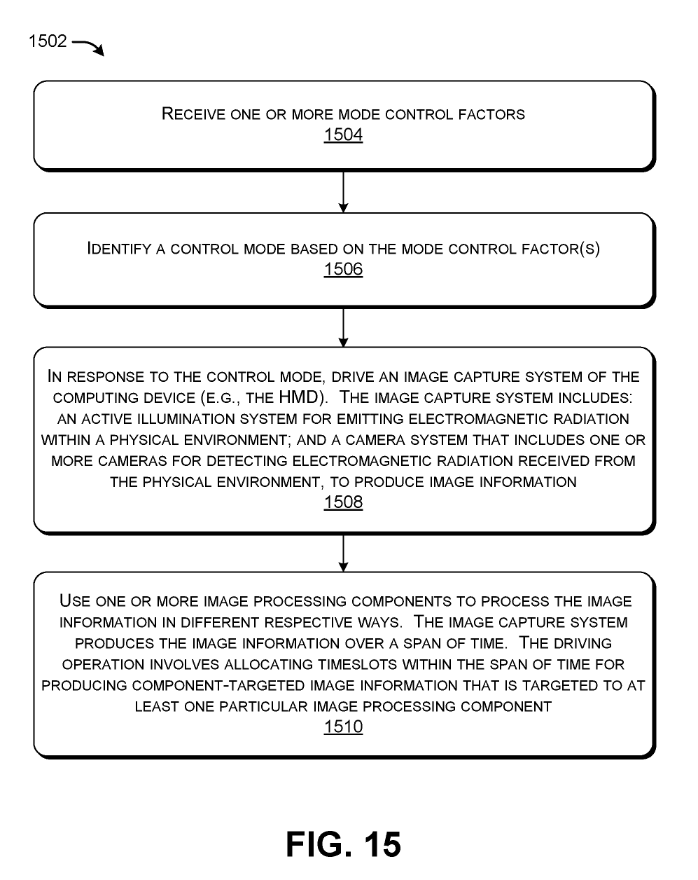

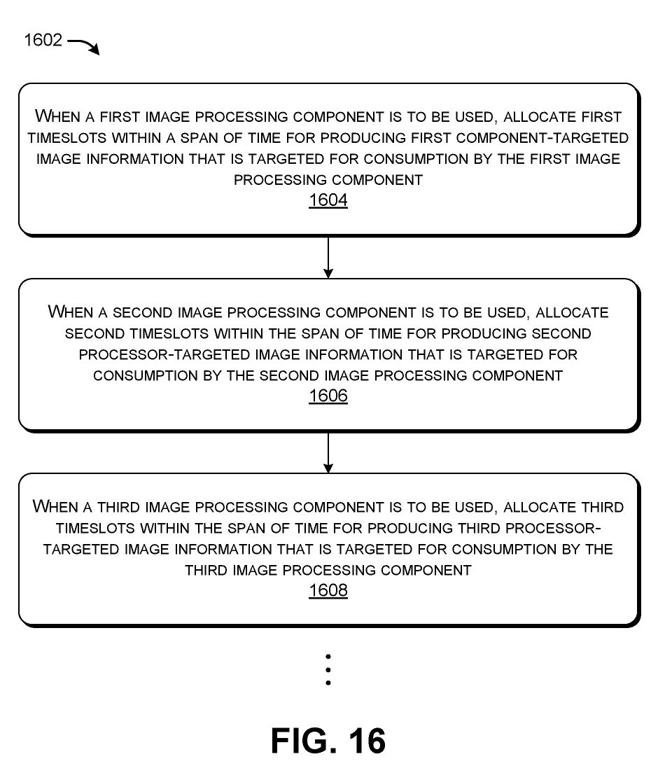

FIGS. 15 and 16 show processes that explain the operation of the HMD 102 of Section A in flowchart form. Since the principles underlying the operation of the HMD 102 have already been described in Section A, certain operations will be addressed in summary fashion in this section. As noted in the prefatory part of the Detailed Description, each flowchart is expressed as a series of operations performed in a particular order. But the order of these operations is merely representative, and can be varied in any manner.

Further note that, while the processes are described in the context of the HMD 102, the processes can more generally be performed by any computing device in any context. For example, the processes can be performed by a computing device associated with a mobile robot of any type.

FIG. 15 shows a process 1502 that represents an overview of one manner of operation of the HMD 102 (or other type of computing device). In block 1504, the HMD 102 receives one or more mode control factors. In block 1506, the HMD 102 identifies a control mode based on the mode control factor(s). In block 1508, in response to the control mode, the HMD 102 drives an image capture system 204 of the HMD 102. The image capture system 204 includes: an active illumination system 208 for emitting electromagnetic radiation within a physical environment; and a camera system 210 that includes one or more cameras for detecting electromagnetic radiation received from the physical environment, to produce image information. In block 1510, the HMD 102 uses one or more image processing components to process the image information in different respective ways. More specifically, the image capture system 204 produces the image information over a span of time, and the driving operation (in block 1508) involves allocating timeslots within the span of time for producing component-targeted image information that is targeted to at least one particular image processing component 212.

FIG. 16 shows a process 1602 that elaborates on the driving operation 1508 of FIG. 15. In block 1604, when a first image processing component is used, the HMD 102 allocates first timeslots within a span of time for producing first component-targeted image information that is targeted for consumption by the first image processing component. In block 1606, when a second image processing component is used, the HMD 102 allocates second timeslots within the span of time for producing second component-targeted image information that is targeted for consumption by the second image processing component. In block 1608, when a third image processing component is used, the HMD 102 allocates third timeslots within the span of time for producing third component-targeted image information that is targeted for consumption by the third image processing component.

C. Representative Computing Functionality

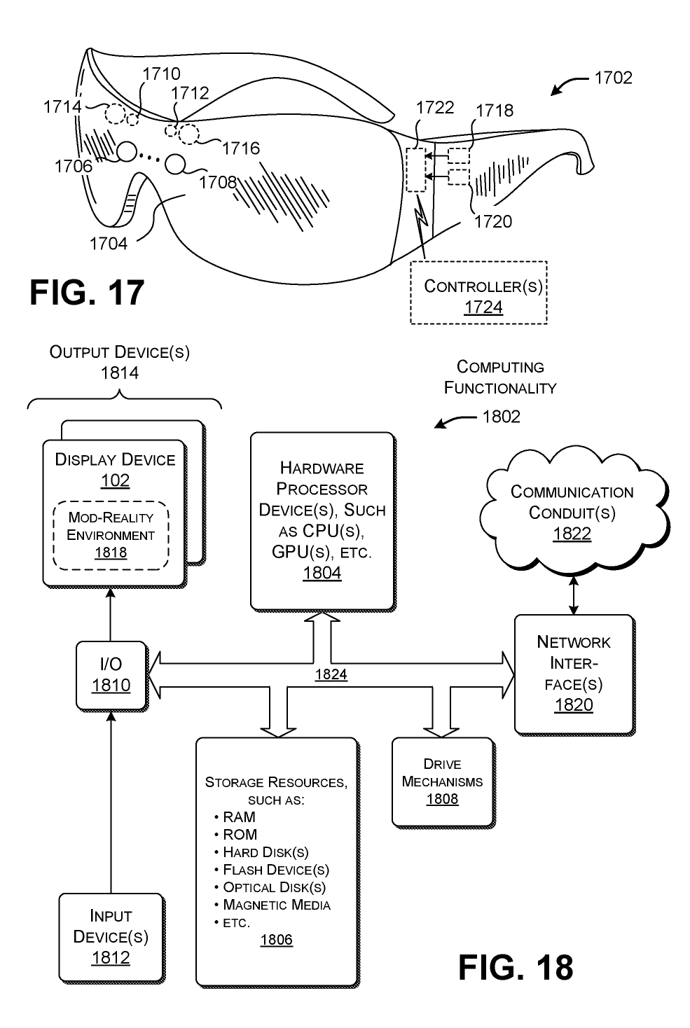

FIG. 17 shows an external representation of a head-mounted display (HMD) 1702, e.g., which corresponds to one implementation of the head-mounted display 102 of FIGS. 1 and 3. The HMD 1702 includes a head-worn frame that houses or otherwise affixes a see-through display device 1704 or an opaque (non-see-through) display device. Waveguides (not shown) or other image information conduits direct left-eye images to the left eye of the user and direct right-eye images to the right eye of the user, to overall create the illusion of depth through the effect of stereopsis. Although not shown, the HMD 1702 can also include speakers for delivering sounds to the ears of the user.

The HMD 1702 can include any environment-facing cameras, such as representative environment-facing cameras 1706 and 1708, which collectively form a camera system. The cameras (1706, 1708) can include grayscale cameras, RGB cameras, etc. While FIG. 17 shows two cameras (1706, 1708), the HMD 1702 can include additional cameras, or a single camera. Although not shown, the HMD 1702 can also include a structured light source which directs structured light onto the surfaces of the physical environment.

The HMD 1702 can optionally include an inward-facing gaze-tracking system. For example, the inward-facing gaze-tracking system can include light sources (1710, 1712) for directing light onto the eyes of the user, and cameras (1714, 1716) for detecting the light reflected from the eyes of the user.

The HMD 1702 can also include other input mechanisms, such as one or more microphones 1718, an inertial measurement unit (IMU) 1720, etc. The IMU 1720, in turn, can include one or more accelerometers, one or more gyroscopes, one or more magnetometers, etc., or any combination thereof.

A control module 1722 can include logic for performing any of the tasks described above. The example, the control module 1722 can include the controller activator 314 (of FIG. 3) for communicating with one or more handheld or body-worn controllers 1724. The control module 722 can also include the set of image processing components 212 shown in FIG. 3.

FIG. 18 more generally shows computing functionality 1802 that can be used to implement any aspect of the mechanisms set forth in the above-described figures. For instance, the type of computing functionality 1802 shown in FIG. 18 can be used to implement the processing functions of the HMD 102 of FIGS. 1 and 3, or, more generally, any computing device which performs the same tasks as the HMD 102. In all cases, the computing functionality 1802 represents one or more physical and tangible processing mechanisms.

The computing functionality 1802 can include one or more hardware processor devices 1804, such as one or more central processing units (CPUs), and/or one or more graphics processing units (GPUs), and so on. The computing functionality 1802 can also include any storage resources (also referred to as computer-readable storage media or computer-readable storage medium devices) 1806 for storing any kind of information, such as machine-readable instructions, settings, data, etc. Without limitation, for instance, the storage resources 1806 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1802. The computing functionality 1802 may perform any of the functions described above when the hardware processor device(s) 1804 carry out computer-readable instructions stored in any storage resource or combination of storage resources. For instance, the computing functionality 1802 may carry out computer-readable instructions to perform each block of the processes described in Section B. The computing functionality 1802 can also include one or more drive mechanisms 1808 for interacting with any storage resource, such as a hard disk drive mechanism, an optical disk drive mechanism, and so on.

The computing functionality 1802 also includes an input/output component 1810 for receiving various inputs (via input devices 1812), and for providing various outputs (via output devices 1814). Illustrative input devices and output devices were described above in the context of the explanation of FIG. 3. For instance, the input devices 1812 can include any combination of video cameras, an IMU, microphones, etc. The output devices 1814 can include a display device 1816 that presents a modified-reality environment 1818, speakers, etc. The computing functionality 1802 can also include one or more network interfaces 1820 for exchanging data with other devices via one or more communication conduits 1822. One or more communication buses 1824 communicatively couple the above-described components together.

The communication conduit(s) 1822 can be implemented in any manner, e.g., by a local area computer network, a wide area computer network (e.g., the Internet), point-to-point connections, etc., or any combination thereof. The communication conduit(s) 1822 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1802 (and its hardware processor(s)) can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc. In this case, the machine-executable instructions are embodied in the hardware logic itself.

The following summary provides a non-exhaustive list of illustrative aspects of the technology set forth herein.

According to a first aspect, a computing device is described that includes an image capture system. The image capture system, in turn, includes: an active illumination system for emitting electromagnetic radiation within a physical environment; and a camera system that includes one or more cameras for detecting electromagnetic radiation received from the physical environment, to produce image information. The computing device also includes a mode control system configured to: receive one or more mode control factors; identify a control mode based on the mode control factor(s); and, in response to the control mode, drive the image capture system. The computing device also includes one or more image processing components configured to process the image information provided by the camera system in different respective ways. More specifically, the image capture system produces the image information over a span of time, and the mode control system is configured to drive the image capture system by allocating timeslots within the span of time for producing component-targeted image information that is targeted for consumption by at least one particular image processing component.

According to a second aspect, the computing device corresponds to a head-mounted display.

According to a third aspect, the camera system includes two visible light cameras.

According to a fourth aspect, one of the image processing components is a pose tracking component that tracks a position of a pose of a user.

According to a fifth aspect, the mode control system is configured to drive the image capture system by producing component-targeted image information for consumption by the pose tracking component during times at which the active illumination system is not illuminating the physical environment with electromagnetic radiation.

According to a sixth aspect, one of the image processing components is a controller tracking component that tracks a position of at least one controller that moves with at least one part of a body of a user.

According to a seventh aspect, the mode control system is configured to drive the image capture system by producing component-targeted image information for consumption by the controller tracking component during times at which the active illumination system activates a light-emitting system of the controller.

According to an eighth aspect, the light-emitting system (of the seventh aspect) includes one or more light-emitting diodes.

According to a ninth aspect, one of the image processing components is a surface reconstruction component that produces a representation of at least one surface in the physical environment.

According to a tenth aspect, the mode control system is configured to drive the image capture system by producing component-targeted image information for consumption by the surface reconstruction component during times at which the active illumination system projects structured light into the physical environment.

According to an eleventh aspect, one of the image processing components is an image segmentation component that identifies different portions within images captured by the camera system.

According to a twelfth aspect, the mode control system is configured to drive the image capture system by producing component-targeted image information for consumption by the image segmentation component during times at which the active illumination system illuminates the physical environment with a pulse of electromagnetic radiation.

According to a thirteenth aspect, one mode control factor is an application requirement specified by an application, the application requirement specifying a subset of image processing components used by the application.

According to a fourteenth aspect, one mode control factor is an instance of image information that reveals that at least one controller is being used in the physical environment by a user. The computing device also includes a mode detector for detecting that at least one controller is being used based on analysis performed on the instance of image information.

According to a fifteenth aspect, a method is described for driving an image capture system of a computing device. The method includes: receiving one or more mode control factors; identifying a control mode based on the mode control factor(s); and, in response to the control mode, driving an image capture system of the computing device. The image capture system includes: an active illumination system for emitting electromagnetic radiation within a physical environment; and a camera system that includes one or more cameras for detecting electromagnetic radiation received from the physical environment, to produce image information. The method also includes using one or more image processing components to process the image information in different respective ways. More specifically, the image capture system produces the image information over a span of time, and the driving operation involves allocating timeslots within the span of time for producing component-targeted image information that is targeted for consumption by at least one particular image processing component.

According to a sixteenth implementation, the driving operation involves allocating timeslots within the span of time for producing: first instances of component-targeted image information that are specifically targeted for consumption by a first image processing component; and second instances of component-targeted image information that are specifically targeted for consumption by a second image processing component.

According to a seventeenth aspect (dependent on the sixteenth aspect), the driving operation further involves allocating timeslots within the span of time for producing third instances of component-targeted image information that are specifically targeted for consumption by a third image processing component.

According to an eighteenth aspect (dependent on the seventeenth aspect), the first image processing component corresponds to a pose tracking component that tracks a pose of a user within the physical environment, wherein the mode control system is configured to drive the image capture system by producing the first instances of component-targeted image information for consumption by the pose tracking component during times at which the active illumination system is not illuminating the physical environment with electromagnetic radiation. The second image processing component corresponds to a controller tracking component that tracks a position of at least one controller that moves with at least one part of a body of the user, wherein the driving operation involves producing the second instances of component-targeted image information for consumption by the controller tracking component during second times at which: the active illumination system activates a light-emitting system of the controller; and at which the active illumination system does not project structured light into the physical environment. The third image processing component corresponds to a surface reconstruction component that produces a representation of at least one surface in the physical environment, wherein the driving operation involves producing the third instances of component-targeted image information for consumption by the surface reconstruction component during third times at which: the active illumination system projects structured light into the physical environment; and at which the active illumination system does not activate the light-emitting system of the controller.

According to a nineteenth aspect, a computer-readable storage medium is described for storing computer-readable instructions. The computer-readable instructions, when executed by one or more processor devices, perform a method that includes: receiving one or more mode control factors; identifying a control mode based on the mode control factor(s); and, in response to the control mode, driving an image capture system of a computing device. The image capture system includes: an active illumination system for emitting electromagnetic radiation within a physical environment; and a camera system that includes one or more cameras for detecting electromagnetic radiation received from the physical environment, to produce image information. The method further includes using a first image processing component, a second image processing component, and a third image processing component to process the image information in different respective ways, any of subset of the first image processing component, the second image processing component, and the third image processing component being active at any given time. More specifically, the image capture system produces the image information over a span of time, and wherein the driving operation involves: when the first image processing component is used, allocating first timeslots within the span of time for producing first component-targeted image information for consumption by the first image processing component; when the second image processing component is used, allocating second timeslots within the span of time for producing second component-targeted image information for consumption by the second image processing component; and when the third image processing component is used, allocating third timeslots within the span of time for producing third component-targeted image information for consumption by the third image processing component. The first timeslots, the second timeslots, and the third timeslots correspond to non-overlapping timeslots.

According to a twentieth aspect (dependent on the nineteenth aspect), the first image processing component corresponds to a pose tracking component that tracks a pose of a user within the physical environment, the second image processing component corresponds to a controller tracking component that tracks a position of at least one controller that moves with at least one part of a body of the user, and the third image processing component corresponds to a surface reconstruction component that produces a representation of at least one surface in the physical environment.

A twenty-first aspect corresponds to any combination (e.g., any permutation or subset that is not logically inconsistent) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device, comprising:
an image capture system that includes:
an active illumination system for emitting electromagnetic radiation within a physical environment; and
a camera system that includes one or more cameras for detecting electromagnetic radiation received from the physical environment, to produce image information;
a mode control system configured to:
receive one or more mode control factors;
identify a control mode based on said one or more mode control factors; and
in response to the control mode, drive the image capture system; and
one or more image processing components configured to process the image information provided by the camera system in different respective ways,
the image capture system producing the image information over a span of time, and
the mode control system being configured to drive the image capture system by allocating timeslots within the span of time for producing component-targeted image information that is targeted for consumption by at least one particular image processing component.

2. The computing device of claim 1, wherein the computing device corresponds to a head-mounted display.

3. The computing device of claim 1, wherein the camera system includes two visible light cameras.

4. The computing device of claim 1, wherein one of the image processing components is a pose tracking component that tracks a position of a pose of a user.

5. The computing device of claim 4, wherein the mode control system is configured to drive the image capture system by producing component-targeted image information for consumption by the pose tracking component during times at which the active illumination system is not illuminating the physical environment with electromagnetic radiation.

6. The computing device of claim 1, wherein one of the image processing components is a controller tracking component that tracks a position of at least one controller that moves with at least one part of a body of a user.

7. The computing device of claim 6, wherein the mode control system is configured to drive the image capture system by producing component-targeted image information for consumption by the controller tracking component during times at which the active illumination system activates a light-emitting system of said at least one controller.

8. The computing device of claim 7, wherein the light-emitting system includes one or more light-emitting diodes.

9. The computing device of claim 1, wherein one of the image processing components is a surface reconstruction component that produces a representation of at least one surface in the physical environment.

10. The computing device of claim 9, wherein the mode control system is configured to drive the image capture system by producing component-targeted image information for consumption by the surface reconstruction component during times at which the active illumination system projects structured light into the physical environment.

11. The computing device of claim 1, wherein one of the image processing components is an image segmentation component that identifies different portions within images captured by the camera system.

12. The computing device of claim 11, wherein the mode control system is configured to drive the image capture system by producing component-targeted image information for consumption by the image segmentation component during times at which the active illumination system illuminates the physical environment with a pulse of electromagnetic radiation.

13. The computing device of claim 1, wherein said one or more mode control factors includes an application requirement specified by an application, the application requirement specifying a subset of image processing components used by the application.

14. The computing device of claim 1,
wherein said one or more mode control factors includes an instance of image information that reveals that at least one controller is being used in the physical environment by a user, and
wherein said computing device includes a mode detector for detecting that said at least one controller is being used based on analysis performed on said instance of image information.

15. A method for driving an image capture system of a computing device, comprising:
receiving one or more mode control factors;
identifying a control mode based on said one or more mode control factors;
in response to the control mode, driving an image capture system of the computing device, the image capture system including:
an active illumination system for emitting electromagnetic radiation within a physical environment; and
a camera system that includes one or more cameras for detecting electromagnetic radiation received from the physical environment, to produce image information; and
using one or more image processing components to process the image information in different respective ways,
the image capture system producing the image information over a span of time, and
said driving involving allocating timeslots within the span of time for producing component-targeted image information that is targeted for consumption by at least one particular image processing component.

16. The method of claim 15, wherein said driving involves allocating timeslots within the span of time for producing:
first instances of component-targeted image information that are specifically targeted for consumption by a first image processing component; and
second instances of component-targeted image information that are specifically targeted for consumption by a second image processing component.

17. The method of claim 16, wherein said driving further involves allocating timeslots within the span of time for producing third instances of component-targeted image information that are specifically targeted for consumption by a third image processing component.

18. The method of claim 17, wherein:
wherein the first image processing component corresponds to a pose tracking component that tracks a pose of a user within the physical environment,
wherein the mode control system is configured to drive the image capture system by producing the first instances of component-targeted image information for consumption by the pose tracking component during times at which the active illumination system is not illuminating the physical environment with electromagnetic radiation,
wherein the second image processing component corresponds to a controller tracking component that tracks a position of at least one controller that moves with at least one part of a body of the user,
wherein said driving involves producing the second instances of component-targeted image information for consumption by the controller tracking component during second times at which: the active illumination system activates a light-emitting system of said at least one controller; and at which the active illumination system does not project structured light into the physical environment,
wherein the third image processing component corresponds to a surface reconstruction component that produces a representation of at least one surface in the physical environment, and
wherein said driving involves producing the third instances of component-targeted image information for consumption by the surface reconstruction component during third times at which: the active illumination system projects structured light into the physical environment; and at which the active illumination system does not activate the light-emitting system of said at least one controller.

19. A computer-readable storage medium for storing computer-readable instructions, the computer-readable instructions, when executed by one or more processor devices, performing a method that comprises:
receiving one or more mode control factors;
identifying a control mode based on said one or more mode control factors;
in response to the control mode, driving an image capture system of a computing device, the image capture system including:
an active illumination system for emitting electromagnetic radiation within a physical environment; and
a camera system that includes one or more cameras for detecting electromagnetic radiation received from the physical environment, to produce image information; and
using a first image processing component, a second image processing component, and a third image processing component to process the image information in different respective ways, any of subset of the first image processing component, the second image processing component, and the third image processing component being active at any given time,
the image capture system producing the image information over a span of time, and
said driving involving:
when the first image processing component is used, allocating first timeslots within the span of time for producing first component-targeted image information for consumption by the first image processing component,
when the second image processing component is used, allocating second timeslots within the span of time for producing second component-targeted image information for consumption by the second image processing component, and
when the third image processing component is used, allocating third timeslots within the span of time for producing third component-targeted image information for consumption by the third image processing component,
wherein the first timeslots, the second timeslots, and the third timeslots correspond to non-overlapping timeslots.

20. The computer-readable storage medium of claim 19,
wherein the first image processing component corresponds to a pose tracking component that tracks a pose of a user within the physical environment,
wherein the second image processing component corresponds to a controller tracking component that tracks a position of at least one controller that moves with at least one part of a body of the user, and
wherein the third image processing component corresponds to a surface reconstruction component that produces a representation of at least one surface in the physical environment.
